(19) United States
(12) Patent Application Publication
(10) Pub. No.: US 2004/0194873 A1
(43) Pub. Date: Oct. 7, 2004

(54) Process and plant for tile manufacture of a pultruded product

(76) Inventor: Alfonso Branca, Milano (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/485,889

(22) PCT Filed: Jul. 31, 2002
(86) PCT No.: PCT/EP02/08527

(30) Foreign Application Priority Data
Aug. 3, 2001 (IT) MI2001A001710

(51) Int. Cl. B29C 70/20; B29C 70/52; B32B 17/04; B32B 27/42

(52) U.S. Cl. 156/180; 264/149; 156/244.19; 156/244.22; 264/261; 428/299.4

(57) ABSTRACT

The process for the manufacture of a pultruded product characterised by the employment of a phenolic resin that is in a solid state at room temperature and is mixed with an appropriate cross-linking agent, by raising the resin and cross-linking agent to a suitable temperature to maintain said phenolic resin in a liquid state, by impregnating a fibreglass with said liquefied phenolic resin, by forming said fibreglass impregnated with resin, as described above, to make the pre-defined product and by subjecting the product to heat treatment for a preset period to allow polymerisation of said resin.

The present finding refers to a process and a plant for the manufacture of a pultruded product.

As is known, the pultrusion process can be used to manufacture section bars with a regular cross-section continuously with composite material.

The impregnation of strengthening fibres is of crucial importance in the pultrusion process. This is usually achieved by feeding them through a tank containing a polymer matrix or resin.

Subsequently, the composite material is fed into a heated die and drawn through it.

As a result the matrix starts to polymerise in order to produce a fibreglass section bar with the required dimensions of the sections protruding the pultrusion die.

Finally, the section bar is cut to the required length.

As a rule, the advantage of pultrusion processes using fibreglass as a strengthening fibre and a thermosetting resin, and especially a liquid phenolic resin at room temperature, as a polymeric matrix is that liquid phenolic resin at room temperature may help to obtain a good impregnation level as it can flow between different fibres of fibreglass.

Nonetheless the drawback of phenolic resins in a liquid state at room temperature is that they pollute the environment with their constituent solvents, such as formaldehyde and phenol.

As a result they may pose an environmental health hazard. Moreover, liquid phenolic resins at room temperature have chemical and physical properties that quickly change over time and are consequently hard to handle and transport. Indeed, liquid phenolic resins at room temperature must be constantly cooled during transportation and must also be stored in a specially cooled place and never for excessively long periods.

Therefore, if on one hand using a liquid phenolic resin at room temperature is recommended in order to employ an appropriate cross-linking agent able to start an isothermal reaction, which in turn starts the polymerisation process when required, on the other the presence of solvents causes the innumerable problems outlined above.

The purpose that the present finding aims to fulfil is to overcome the prior art drawbacks outlined above, however without as a result having to forego its intrinsic advantages.

To accomplish this purpose, an important object of the finding is to develop a process and a plant that can produce a pultruded product without causing solvents to evaporate during the process, so as to create a healthy work environment.

Another object of the finding is to develop a process and a plant that allow the use of a polymeric matrix that does not change over time and need not be constantly heat-treated for its maintenance so that it can be easily handled, transported and stored.

The last but not least object of the finding is to develop a process and a plant that can produce a pultruded product with mechanical strength properties that are as good or better than those achieved with known processes and plants.

The aforesaid technical purpose and the stated objects are essentially accomplished by a pultruded product manufacturing process characterised by the employment of a phenolic resin in the solid state at room temperature, which is mixed with an appropriate cross-linking agent, when raising or lowering said resin and cross-linking agent to an adequate temperature to keep phenolic resin as described above in a liquid state at room temperature, when impregnating a fibreglass with liquefied phenolic resin as described, when forming the impregnated fibreglass with resin as described above to make the pre-defined product and when heat-treating the product for a preset time to polymerise the resin.

This process is initiated with a pultruded product manufacturing plant, which is characterised in that it comprises melting means able to transform a solid phenolic resin at room temperature into a liquid state, liquid phenolic resin storage units, means adapted to impregnate a mass of fibreglass with solid phenolic resin maintained in a liquid state as described above, means adapted to keep fibreglass as described above in the liquid state of the impregnating resin and means adapted to form fibreglass impregnated with resin to obtain the predefined product.

Appropriately, the product made by pultrusion with the aforesaid process and plant is characterised in that it consists of a mass of fibreglass impregnated by a solid phenolic resin at room temperature and containing an appropriate cross-linking agent.

Another innovative breakthrough is the employment of a solid phenolic resin at ambient temperature to impregnate a mass of fibreglass for the manufacture of products by means of the pultrusion process.

Further characteristics and advantages of the invention will be more evident with the description of a preferred non limiting embodiment of a process and plant for the manufacture of a pultruded product according to the invention, as illustrated by way of an example in the attached drawing in which:

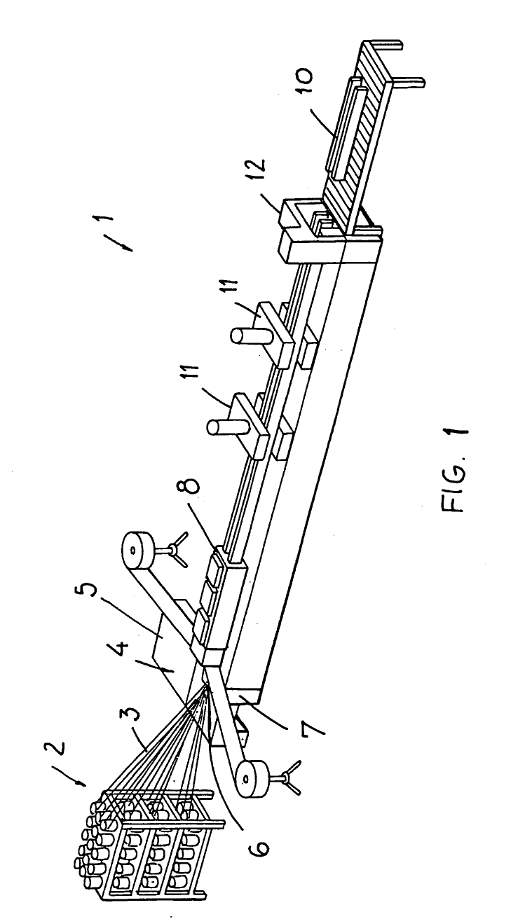

FIG. 1 shows a schematic view of a plant to carry out a pultrusion process according to the invention.

With reference to the aforesaid FIGURE, the process according to the finding consists of the following succession of phases.

At the beginning the process uses a phenolic resin that is in a solid state at ambient temperature and contains an appropriate cross-linking agent.

The resin and cross-linking agent are heated to an adequate temperature to maintain phenolic resin in a liquid state at room temperature without triggering a polymerisation process. Subsequently, a fibreglass is impregnated with liquefied phenolic resin and the composite material (fibreglass impregnated with phenolic resin) is formed with the predefined geometry to obtain the required product.

Last but not least, the resulting product is heat-treated for a preset period to let the cross-linking agent polymerise the resin.

In particular, the fibreglass is impregnated with phenolic resin containing an appropriate cross-linking agent at an initial temperature, while it is subjected to a second temperature higher than the first temperature, after the product has been made, to let it polymerise to the required dimensions.

The cross-linking agent that is injected into the phenolic resin in a solid state at room temperature consists of hexamine and particularly of hexamine that has been encapsulated, so that its melting point is higher than that of phenolic resin, and from a solid state must change into a liquid state at room temperature, without triggering polymerisation.

In particular, hexamine is encapsulated by using a polymer to encapsulate hexamine with a preset melting temperature depending on requirements.

The polymer is dissolved in a solvent, in which hexamine can clearly not dissolve, selected from chemicals that are not soluble in phenolic resin.

The percentage of dissolved polymer is varied depending on the required encapsulation thickness.

Subsequently the solvent is removed by evaporation in a thin layer or fluid bed, either in atmospheric pressure or in a vacuum.

The plant used to make a pultruded product, generally indicated with numeral 1, consists of a spool-holder 2 that houses fibreglass strands 3 and feeds them to the impregnation area, generally marked by 4.

The plant consists of melting means 5 used to raise solid phenolic resin at room temperature to a liquid state.

In particular, the melting means comprises a melting device or an extruder 5 adapted to feed resin its storage means, defined for example by a tank 6, directly with liquefied phenolic.

Tank 6 contains means used to impregnate fibreglass mass with solid phenolic resin maintained in a liquid state.

The impregnating means may be formed by impregnating units, which are not represented, rather than either by cylinders able to allow fibreglass to immerse and stretch in the resin, or by a dipping roller designed to raise the resin kept in a liquid state above the fibreglass during its transfer.

Appropriately, tank 6 is equipped with means adapted to maintain the resin that impregnates fibreglass 3 in a liquid state.

The resin liquid state stabilisers may for instance be electric resistance 7 or any other device suitable for the purpose.

The plant is also provided with forming means 8 for the fibreglass impregnated with resin to obtain predefined product 10.

Obviously, the forming means consisting of a pultrusion die are heated to the required temperature.

The plant also contains, in a known manner, a stretching mechanism 11 which may consists of a belt-drive or two alternate trolleys, to ensure continuous motion.

Finally, a cutting station 12 is used to cut the section bar to the required length.

As mentioned above, the phenolic resin employed in the plant contains a cross-linking agent composed of encapsulated hexamine.

Furthermore product 10 obtained with the process and the plant described above is advantageously composed of a fibreglass mass impregnated by solid phenolic resin at ambient temperature using encapsulated hexamine as a cross-linking agent.

The invention achieves the forseen objects and presents a number of important advantages.

As a matter of fact, we have developed a new process and a new plant that allow us to take all the advantages inherent in the use of a fluid resin, but at the same time eliminating all the disadvantages that phenolic resin in a liquid state at room temperature causes as a result of its solvents.

The invention as described above is susceptible to numerous alterations and variants, all falling within the scope of the present invention.

In addition, all details may be replaced by technically equivalent elements.

The materials employed, shapes and dimensions may be varied to meet requirements.

1. Process for the manufacture of a pultruded product characterized by the employment of a phenolic resin that is in a solid state at room temperature and is mixed with an appropriate cross-linking agent by raising the resin and cross-linking agent to a suitable temperature to maintain said phenolic resin in a liquid state, by impregnating a fibreglass with said liquefied phenolic resin, by forming said fibreglass impregnated with resin, as described above, to make the pre-defined product and by subjecting the product to heat treatment for a preset period to allow polymerization of said resin.

2. Process for the manufacture of a pultruded product according to claim 1, characterized in that said fibreglass is impregnated with phenolic resin along with the cross-linking agent, as described above, at an initial temperature and after said product has been made it is heated to a second temperature higher than the first temperature.

3. Process for the manufacture of a pultruded product according to claim 1, characterized in that said cross-linking agent consists of hexamine.

4. Process for the manufacture of a pultruded product according to claim 1, characterized in that hexamine is encapsulated before being mixed with the said resin.
